(19) United States
(12) Patent Application Publication
(10) Pub. No.: US 2026/0065633 A1
(43) Pub. Date: Mar. 5, 2026

(54) SYSTEMS AND METHODS FOR EXTRACTING WAVEFORMS FROM A DIGITAL IMAGE

(71) Applicant: POWERFUL MEDICAL s.r.o., New York, NY (US)

(72) Inventors: Simon ROVDER, Tomasov (SK); Boris VAVRIK, Bratislava (SK); Vladimir BOZA, Bratislava (SK); Adam RAFAJDUS, Bratislava (SK); Michal HOJCKA, Bratislava (SK)

(21) Appl. No.: 19/316,873

(22) Filed: Sep. 2, 2025

Related U.S. Application Data
(60) Provisional application No. 63/689,536, filed on Aug. 30, 2024.

(51) Int. Cl. G06V 10/75; G06V 10/22

(52) U.S. Cl. CPC G06V 10/751; G06V 10/23

(57) ABSTRACT

In various embodiments, computer-implemented systems and methods for extracting pixel trajectories representing waveforms from a digital image, formed by lines and columns of picture elements, pixels, of a recording of an electrical activity of a human organ detected by on-skin electrodes, such as an electrocardiogram, ECG, or an electroencephalogram, EEG, are provided.

### CROSS-REFERENCE

This application claims priority to U.S. Provisional Application No. 63/689,536, filed Aug. 30, 2024, which is hereby incorporated in its entirely.

### FIELD OF THE INVENTION

The present application relates to systems and methods for extracting waveforms from a digital image. In particular, the present invention relates to systems and methods for digitizing paper electrocardiogram records.

### INTRODUCTION

Electrocardiogram (ECG) is a common, wide-spread and well-established clinical tool used for fast, inexpensive and non-invasive assessment of cardiac health. Although the ECG has been used in clinical medicine for decades, the standardization of the output format is still missing. Today, ECGs are routinely recorded and archived in numerous paper and digital formats. A uniform digital format of existing ECGs would greatly facilitate research efforts by allowing simpler and hurdle-free access to data. Additionally, an easy-to-use tool for conversion from paper to digital format would enable an uncomplicated storage of patient ECGs in places where paper-based ECGs are still common.

As suggested in published literature (Kothadia et al., 2013, Waits and Soliman, 2017), there is a conflict between the patient-centered research interest of format standardization and the economic interest of ECG manufacturers maintaining the ECG formats incompatible with each other. Therefore, it is highly unlikely that the compatibility of the ECG format would be an initiative of the ECG manufacturers. Nevertheless, development of a tool that unifies various formats would be of great interest to researchers.

Numerous approaches to digitize paper-based ECGs were developed over the past 30 years with various degree of functionality (Zhang et al., 1987; Widman and Hines, 1991; Bhullar et al., 1993; Wang and Mital, 1996; Lobodzinski et al., 2003; Mitra et al., 2004; Badilini et al., 2005; Chebil et al., 2008; Ravichandran et al., 2013; Patil and Karandikar, 2018; Baydoun et al., 2019; Li et al., 2020).

Previous studies on ECG digitization have used as an input a scanned image of a paper ECG (Zhang et al., 1987; Widman and Hines, 1991; Bhullar et al., 1993; Wang and Mital, 1996; Lobodzinski et al., 2003; Mitra et al., 2004; Badilini et al., 2005; Chebil et al., 2008; Ravichandran et al., 2013; Patil and Karandikar, 2018; Baydoun et al., 2019; Li et al., 2020). Some studies (Lobodzinski et al., 2003; Badilini et al., 2005; Ravichandran et al., 2013) have taken advantage of the background gridline present in paper ECGs and introduced skew correction, where two points along the same ECG gridline are selected, the skewed angle is calculated, and the image is rotated accordingly. The skew correction may serve as a preparatory step to optimize signal extraction.

During signal extraction, a crucial step of digitization procedure, the grid is typically removed, and the ECG signal is extracted. Since the first algorithm to preform ECG signal extraction from paper-based ECGs, which was documented more than thirty years ago (Zhang et al., 1987), there has been a tremendous improvement in the precision of signal digitization. Older algorithms used various methods to separate ECG signals from the grid, such as thresholding of grayscale value, color, thickness or other means of distinction (Zhang et al., 1987; Bhullar et al., 1993; Wang and Mital, 1996; Mitra et al., 2004; Badilini et al., 2005; Chebil et al., 2008; Ravichandran et al., 2013; Patil and Karandikar, 2018). These approaches inherently led to a high degree of noise and signal omission in the digitized ECG signal, especially in paper-based ECGs with paper distortions, shadows, scratches, weaker printings, or other quality flaws. Currently, there is one algorithm documented that uses a deep neural network (DNN) to perform automated signal extraction from paper-based ECGs achieving superior results in highly noisy records (Li et al., 2020).

Even though the signal extraction step is intended to represent an actual digitization of the signal, at this stage the ECG signal is discontinuous and may require a continuity algorithm to generate continuous ECG signals through interpolation. This step may be referred to as signal refinement. In situations in which the individual curves in an ECG overlay one another, signal refinement is particularly challenging. As noted in published literature (Baydoun et al., 2019), Matlab-based tools exist which allow not only for the generation of continuous ECG signals, but are also able to automatically separate individual ECG leads. Nevertheless, the algorithm developed by Baydoun et al., is restricted to ECGs scanned without distortions and its performance on ECG scans with overlapping signals is questionable.

In view of the various approaches reported above, the present invention aims to provide robust and fully automatic systems and methods of transforming paper ECG records into digital representations thereof.

### SUMMARY OF THE INVENTION

Various embodiments of the present invention relate to computer-implemented systems and methods for extracting waveforms from a digital image. Various embodiments of the present invention may serve as, e.g., a module in an application which, for example, may be run on a mobile phone or other computing device and may enable fully automatic digitization of paper-based ECGs. Embodiments described herein may use a DNN to repair distortions that are inherent to taking photographs of paper-based documents, such as ECGs, to separate ECG signals from the background using a distinct DNN and to automatically visualize individual ECG leads from various layouts in a standardized output format.

In various embodiments, computer-implemented systems and methods for extracting pixel trajectories from a digital image of a recording of an electrical activity of a human organ detected by on-skin electrodes, such as an electrocardiogram, ECG, or an electroencephalogram, EEG, is provided.

The digital image on which embodiments of the method operate may be formed by lines and columns of picture elements, e.g., pixels. The pixel trajectories may represent continuous waveforms, which will be referred to as leads in the following.

The electrical activity of the human organ comprises a predetermined number of signals from respective electrodes recorded in subsequent rows oriented along lines in the digital image.

In an initial step, the method according to various embodiments may include obtaining a grayscale image segmented from digitized ECG or EEG signals recorded on a substrate comprising, e.g., paper. The grayscale image may contain several continuous waveforms, each one representing a signal recorded by a respective electrode. From an algorithmic view, the input image may be seen to correspond to a grayscale mask, in which for each pixel the corresponding value between 0 and 255 indicates the confidence of a lead crossing that pixel. In the grayscale image, the waveforms may be present in a stacked arrangement, e.g., one below the other (or above, depending on the viewpoint). There may be regions where portions of vertically adjacent waveforms overlap. At this stage of the method, in some embodiments, the waveforms in the grayscale image may not yet be known, e.g., they do not correspond to distinct structures in the grayscale image. The aim of the subsequent steps is to extract the leads from the grayscale image.

In a next step, the method according to various embodiments may include, for each column of pixels in the segmented grayscale image, referred to as a “test column” hereinafter, designating one or more pixels in a respective test column, having grayscale values above a predetermined first threshold, as candidate lead pixels (defined, e.g., by x and y coordinates), by associating them with their respective line and column numbers in the segmented image and associating them with respective ranks according to their appearance in the test column, referred to as lead indices.

In this step of the method according to one or more embodiments, the algorithm processes the grayscale image column by column and identifies pixels which are distinct from the background in each column, e.g., pixels which have a grayscale value above the predetermined first threshold. It is assumed that most of the identified pixels correspond to a candidate lead pixel—a pixel which belongs to a respective waveform. At this step, identification of false candidate pixels in the form of false positives in the segmented mask may occur, e.g., where the pixels are bright enough. However, such false candidate lead pixels are not assigned to any of the leads, as their distance from the baseline is too large. The lead index allocated to each candidate lead pixel may be seen as a counter which, at least for non-interfering portions of the leads, is used for “bookkeeping” with respect to the candidate lead pixels identified in each test column and their corresponding lead. In an exemplary scenario, if six rows have been detected based on an evaluation of local maxima in an image and seven candidate lead pixels have been identified in a column, then those seven lead candidate pixels will not be assigned to the leads in order to avoid false allocation of lead candidate pixels to the leads.

In case there are multiple vertically neighboring candidate lead pixels (i.e. having grayscale values above the predefined first threshold), the middle candidate lead pixel may be used as the representative pixel and referred to as the lead pixel. Practically, this step may correspond, for example, to selecting the middle pixel of the respective lead, as the width of the lead is usually larger than one pixel. In addition, lead pixels need to be consecutively apart more than a predetermined second threshold.

In a next step the method according to various embodiments comprises determining a left and a right margin as first column and a last column of the segmented image which have a predetermined number of lead pixels associated with the first and the last column, respectively, and restricting the segmented image to the left and right margins while maintaining line and column numbers.

This step aims at restricting the segmented image to a region of interest, which is spanned by the first column and the last column with respect to the extent of the waveforms. In columns which do not contain any leads (empty columns) or only a fraction of the actual number of leads present in the segmented image, the lead pixel count drops significantly, optimally to zero. The predetermined number of pixels used as a threshold to distinguish columns containing a significant number of the leads present in the image (non-empty column) from empty columns may correspond to a median of the number of lead pixels (or a value somewhat below that) detected in the columns between the first column and the last column. In some embodiments, instead of the median, the average number of lead pixels may be calculated and rounded to a whole number, e.g., if it is a non-whole number. In that sense, the first column may correspond to the first non-empty column and the last column may correspond to the last non-empty column.

In a next step the method according to various embodiments comprises, for each lead index associated with respective lead pixels, determining a median value of respective line numbers, referred to as a baseline of said lead pixels. In some embodiments, the baseline may alternatively be determined by analyzing histograms of pixel brightness across each column, where peaks or troughs in intensity distributions indicate the expected lead position. In other embodiments, the processor may identify baseline positions by selecting the brightest or darkest pixels per column, depending on whether the waveform is rendered as a dark trace on a light background or the inverse. These approaches may be used alone or in combination with median-based calculations to ensure accurate baseline placement under conditions of noise, skew, or overlapping leads. The baseline may be seen to correspond to a line which lies close to the corresponding lead and provides a first approximation for its location in the segmented image.

In further embodiments of the method, after the lead baselines have been defined, for each column, if there is exactly one lead pixel for each baseline, all such pixels are assigned to respective leads. The statement that there is a lead pixel for a respective baseline may be translated into a requirement that the lead pixel lies within a vicinity of the baseline, which may be defined by a maximum distance (in pixels) of the considered lead pixel from that baseline. If not all baselines can be assigned a lead pixel, the considered column is skipped, without its lead pixels being assigned to respective leads, and the next column is evaluated. In other words, in a situation where there is a mismatch between the number of lead pixels and the number of baselines, an allocation of lead pixels to leads may not take place. The reason for this is that it is not known whether an n-th lead pixel should be allocated to the (n−1)th lead, n-th lead or (n+1)th lead at this stage of the method. For example, in regions of QRS complexes (a series of deflections in the ECG that represent the depolarization of ventricles, e.g., electrical activity of the heart's ventricles before they contract), the leads usually have the form of high-amplitude zig-zag curves. In those cases, a lead pixel which actually belongs to the first lead may lie close to the baseline of the second lead and at this stage of the method it is not known which lead pixel is missing when there a mismatch between the number of lead pixels and the number of baselines.

In further embodiments, the method may include visiting each lead pixel, referred to as a “source pixel,” of one or more pixel columns within the first and last column of the segmented grayscale image, referred to as current columns, and for each source pixel in a respective current column, having a neighboring column devoid of lead pixels at most one subsequent column apart from the current column, repeating the following step: for each plurality of pixels, referred to as target pixels, at most a predetermined number of pixels up and down the current column and said neighboring column, respectively, searching in a respective plurality of target pixels for a target pixel having a grayscale value above a predetermined third threshold and yielding a mean grayscale value of pixels between the source pixel and said target pixel above the predetermined third threshold. If a target pixel has been found in the search phase, designating said target pixel as lead pixel by associating it with its line and column number in the segmented image and associating it with the lead index associated with the source pixel.

The method step described above may correspond to a first refinement of the method according to the invention in that it comes into play when a test column between the first column and the last column is encountered which does not contain lead pixels. This may happen because, for some reason or other, the original image did not contain information with regard to waveforms in that column, or because the test column does contain at least one lead pixel, but the at least one lead pixel has not been detected yet by the method according to various embodiments in the previous steps. In that case, the vicinity of each source pixel is searched for a candidate lead pixel, which may be seen to correspond to a target pixel satisfying certain conditions. The vicinity is defined by the group of target pixels, which are at most a predetermined number of pixels up and down the current column and said neighboring column from the considered source pixel. The vicinity is searched for a target pixel i) having a grayscale value above the predetermined third threshold, and ii) yielding a mean grayscale value of pixels between the source pixel and a said target pixel which lies above the predetermined third threshold. If such a target pixel is found, in some embodiments, that target pixel may be defined as a lead pixel. With regard to the lead indices, that newly identified target pixel is associated with its own line and column number in the segmented image and with the lead index of the source pixel. The association of the newly identified lead pixel with the lead index of the source pixel may be understood by viewing, figuratively, the considered source pixel as an end of a cliff from which the next viable steppingstone—which has not yet been identified—is searched, i.e. the newly identified lead pixel.

In some embodiments, once a segmentation mask has been obtained, the conversion of the mask into a continuous digital signal may be performed using skeletonization techniques executed by at least one processor. Skeletonization algorithms, such as the Zhang-Suen thinning procedure, may iteratively remove pixels from the periphery of detected regions until a one-pixel-wide centerline remains, thereby defining a precise trajectory of the lead. In additional embodiments, clustering methods such as k-means or density-based spatial clustering of applications with noise (DBSCAN) may be applied to group candidate signal pixels into coherent clusters, which may then be ordered column by column to reconstruct the underlying waveform.

In further embodiments, navigation-based approaches adapted from autonomous vehicle road-following algorithms may be implemented. In such cases, the processor may treat each detected lead as a path and apply steering logic to follow the brightest or most continuous route across the image, ensuring that the reconstructed trajectory aligns with the physiological waveform. Other embodiments may employ boundary-based extraction, in which enclosed non-signal regions are identified and the bordering pixel paths are extracted as the corresponding leads. Heuristic search algorithms, such as A*, best-first search, breadth-first search, or depth-first search, may also be used to traverse pixel graphs generated from the mask. A cost function may be defined based on grayscale intensity, distance from the baseline, or continuity with neighboring pixels, enabling the processor to select the path that most likely represents the true lead. Collectively, these mask-to-signal alternatives provide robust options for converting static pixel regions into dynamic digital signals under diverse image conditions.

In further embodiments of the method, the method step described in the previous paragraph may be carried out for each source pixel in a respective current column, having a neighboring column devoid of lead pixels at most one preceding column apart from the current column. Expressed differently, the method step described above may be performed in forward direction along a potential pixel trajectory or in backward direction along a potential pixel trajectory.

In further embodiments of the method, the step of designating a pixel as lead pixel is restrictable by a distance of said pixel to a corresponding baseline. This means that the status of a lead pixel with certain lead indices may be contingent upon the distance of the considered lead pixel from the corresponding baseline, i.e. the baseline determined on the basis of lead pixels with the same pixel indices.

The method according to various embodiments, as disclosed herein, may be advantageously used in the context of a method for automatically digitizing shots/photographs of paper ECGs taken with a mobile phone (instead of scans), which may simplify and speed up the process of ECG digitization.

In some aspects, the techniques described herein relate to a computer-implemented method for extracting leads from a digital image, including: obtaining a grayscale image segmented from one or more digitized signals; in each column of pixels in the segmented grayscale image: designating one or more pixels in a respective test column having grayscale values above a predetermined first threshold as candidate lead pixels, and designating candidate lead pixels which are consecutively apart more than a predetermined second threshold, or for vertically neighboring candidate lead pixels corresponding to a middle candidate lead pixel, as lead pixels by: associating the candidate lead pixels with their respective line numbers and column numbers in the segmented grayscale image; and associating them with respective ranks according to their appearance in the test column, referred to as lead indices; determining a left margin as a first column and a right margin as a last column of the segmented grayscale image, wherein a predetermined number of lead pixels are associated with the first column and the last column, respectively, and restricting the segmented grayscale image to the left and right margins while maintaining line numbers and column numbers; and for each lead index associated with respective lead pixels, determining a baseline of said lead pixels.

In some aspects, the techniques described herein relate to a method, further including: visiting one or more source pixels of one or more pixel columns within the first column and the last column of the segmented grayscale image, and for each source pixel in a respective current column, having a neighboring column devoid of lead pixels at most one subsequent column apart from the current column, repeating the following step: for each of a plurality of target pixels, at most a predetermined number of pixels at least one of up or down the current column and said neighboring column, respectively: searching in a respective plurality of target pixels for a target pixel having a grayscale value above a predetermined third threshold and yielding a mean grayscale value of pixels between the source pixel and a said target pixel above a predetermined third threshold; and if a target pixel has been found, designating said target pixel as lead pixel by associating it with its line number and column number in the segmented grayscale image and associating it with the lead index associated with the source pixel.

In some aspects, the techniques described herein relate to a method, wherein said method is additionally carried out for each source pixel in a respective current column having a neighboring column devoid of lead pixels at most one preceding column apart from the current column.

In some aspects, the techniques described herein relate to a method, wherein designating a pixel as a lead pixel is restrictable by a distance of said pixel to a corresponding baseline.

In some aspects, the techniques described herein relate to a method, wherein the image is recorded on a substrate including paper.

In some aspects, the techniques described herein relate to a method, wherein the one or more digitized signals include recordings of the electrical activity of a human organ detected by on-skin electrodes.

In some aspects, the techniques described herein relate to a method, wherein the recording of the electrical activity is one of electrocardiogram (ECG) or electroencephalogram (EEG) signals.

In some aspects, the techniques described herein relate to a method, wherein the electrical activity includes a predetermined number of signals from respective electrodes recorded in subsequent rows oriented along lines in the digital image.

In some aspects, the techniques described herein relate to a method, wherein determining the baseline of said lead pixels includes determining the median value of respective line numbers.

In some aspects, the techniques described herein relate to a system for extracting leads from a digital image, including: a processor; a memory connected to the processor;

and one or more code sets stored in the memory and executing in the processor, which, when executed configure the system to: obtain a grayscale image segmented from one or more digitized signals; in each column of pixels in the segmented grayscale image: designate one or more pixels in a respective test column having grayscale values above a predetermined first threshold as candidate lead pixels, and designate candidate lead pixels which are consecutively apart more than a predetermined second threshold, or for vertically neighboring candidate lead pixels corresponding to a middle candidate lead pixel, as lead pixels by: associating the candidate lead pixels with their respective line numbers and column numbers in the segmented grayscale image; and associating them with respective ranks according to their appearance in the test column, referred to as lead indices; determine a left margin as a first column and a right margin as a last column of the segmented grayscale image, wherein a predetermined number of lead pixels are associated with the first column and the last column, respectively, and restricting the segmented grayscale image to the left and right margins while maintaining line numbers and column numbers; and for each lead index associated with respective lead pixels, determine a baseline of said lead pixels.

In some aspects, the techniques described herein relate to a system, further configured to: visit one or more source pixels of one or more pixel columns within the first column and the last column of the segmented grayscale image, and for each source pixel in a respective current column, having a neighboring column devoid of lead pixels at most one subsequent column apart from the current column, repeat the following step: for each of a plurality of target pixels, at most a predetermined number of pixels at least one of up or down the current column and said neighboring column, respectively: search in a respective plurality of target pixels for a target pixel having a grayscale value above a predetermined third threshold and yielding a mean grayscale value of pixels between the source pixel and a said target pixel above a predetermined third threshold; and if a target pixel has been found, designate said target pixel as lead pixel by associating it with its line number and column number in the segmented grayscale image and associating it with the lead index associated with the source pixel.

In some aspects, the techniques described herein relate to a system, further configured to execute for each source pixel in a respective current column having a neighboring column devoid of lead pixels at most one preceding column apart from the current column.

In some aspects, the techniques described herein relate to a system, wherein designating a pixel as a lead pixel is restrictable by a distance of said pixel to a corresponding baseline.

In some aspects, the techniques described herein relate to a system, wherein the image is recorded on a substrate including paper.

In some aspects, the techniques described herein relate to a system, wherein the one or more digitized signals include recordings of the electrical activity of a human organ detected by on-skin electrodes.

In some aspects, the techniques described herein relate to a system, wherein the recording of the electrical activity is one of electrocardiogram (ECG) or electroencephalogram (EEG) signals.

In some aspects, the techniques described herein relate to a system, wherein the electrical activity includes a predetermined number of signals from respective electrodes recorded in subsequent rows oriented along lines in the digital image.

In some aspects, the techniques described herein relate to a system, wherein determining the baseline of said lead pixels includes determining the median value of respective line numbers.

In some aspects, the techniques described herein relate to a non-transitory computer-readable media including instructions that, when executed by one or more processors, cause operations including: obtaining a grayscale image segmented from one or more digitized signals; in each column of pixels in the segmented grayscale image: designating one or more pixels in a respective test column having grayscale values above a predetermined first threshold as candidate lead pixels, and designating candidate lead pixels which are consecutively apart more than a predetermined second threshold, or for vertically neighboring candidate lead pixels corresponding to a middle candidate lead pixel, as lead pixels by: associating the candidate lead pixels with their respective line numbers and column numbers in the segmented grayscale image; and associating them with respective ranks according to their appearance in the test column, referred to as lead indices; determining a left margin as a first column and a right margin as a last column of the segmented grayscale image, wherein a predetermined number of lead pixels are associated with the first column and the last column, respectively, and restricting the segmented grayscale image to the left and right margins while maintaining line numbers and column numbers; and for each lead index associated with respective lead pixels, determining a baseline of said lead pixels.

In some aspects, the techniques described herein relate to a non-transitory computer-readable media, further including: visiting one or more source pixels of one or more pixel columns within the first column and the last column of the segmented grayscale image, and for each source pixel in a respective current column, having a neighboring column devoid of lead pixels at most one subsequent column apart from the current column, repeating the following step: for each of a plurality of target pixels, at most a predetermined number of pixels at least one of up or down the current column and said neighboring column, respectively: searching in a respective plurality of target pixels for a target pixel having a grayscale value above a predetermined third threshold and yielding a mean grayscale value of pixels between the source pixel and a said target pixel above a predetermined third threshold; and if a target pixel has been found, designating said target pixel as lead pixel by associating it with its line number and column number in the segmented grayscale image and associating it with the lead index associated with the source pixel.

Various other aspects, features, and advantages of the disclosure will be apparent through the detailed description and the drawings attached hereto. It is also to be understood that both the foregoing general description and the following detailed description are exemplary and not restrictive of the scope of the disclosure.

### BRIEF DESCRIPTION OF DRAWINGS

The general description of the invention provided above and possible embodiments thereof, as well as its purposes and features, will become more apparent with reference to the following figures and detailed description, which are directed towards exemplary embodiments of the present invention.

FIG. 1 illustrates an exemplary process flow based on the method for extracting pixel trajectories representing waveforms according to various embodiments.

FIG. 2 illustrates an evaluation of local maxima in an image comprising several waveforms.

FIG. 3A illustrates a determination of baselines for the individual waveforms.

FIG. 3B illustrates how an image comprising several waveforms may be split into parts.

FIG. 4 illustrates an exemplary intermediate step of the method of the present invention in which extraction of lead pixels close to the baseline is performed.

FIG. 5 illustrates an exemplary intermediate step of the method of the present invention where further portions of the signals have been extracted before signal swapping.

FIG. 6 illustrates the state of the signal extraction from the step illustrated in FIG. 5 after signal swapping.

FIG. 7 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF THE INVENTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field of automating the provision of evaluation requests. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

The following description of embodiments of the present invention refers to ECG signals as exemplary waveforms which are extracted from a digital image. The paper-based ECGs serving as a basis for the explanation of embodiments of the method of the present invention may be retrieved from medical records of patients admitted to a hospital, e.g., where standard 12-lead ECGs are recorded on paper. The paper speed may typically (but not only) be 25 mm/s and the calibration is typically 10 mm/mV. The paper-based ECGs may be photographed using built-in cameras of various mobile phones and tablets to obtain digital images thereof.

In some embodiments, the input image may additionally be derived from sources beyond direct photographic capture. For example, the image may comprise a scanned document rendered in Portable Document Format (PDF), which may be converted into raster graphics suitable for pixel-level analysis. In such cases, a processor may normalize the resolution of the scanned document, convert color or grayscale variations into consistent formats, and correct skew or alignment inconsistencies introduced by the scanning process. In further embodiments, the image may originate from a screen capture of a medical record displayed on a monitor or other device. Such images may contain anti-aliasing artifacts or compression noise, and the processor may apply pre-processing steps such as deblurring, resampling, or artifact suppression to restore fidelity prior to segmentation.

In still other embodiments, the input image may be altered by consumer-grade image filters, including commercial imaging filters or equivalent tools, which may introduce changes to contrast, brightness, hue, or saturation. A processor may execute normalization routines to counteract such distortions, ensuring that the underlying waveform remains recoverable despite non-clinical alterations to the image appearance. In additional embodiments, optical scanning devices, such as barcode scanners or flatbed scanners configured for high-speed ingestion, may be employed to capture ECG traces embedded in various records. These inputs may require de-skewing operations, adjustment for line-scan artifacts, and calibration of bit depth or grayscale intensity to produce a standardized representation. By encompassing such diverse input types, the disclosed methods may operate effectively across heterogeneous acquisition pipelines and thereby increase the likelihood that legacy or unconventional ECG formats can be digitized accurately.

The term “waveform,” as used in this description, may refer to any signal which is indicative of electrical activity within the human or animal body. Most prominently, the waveform (or group of waveforms, if the recording of electrical activity includes acquisition of more than one signal) may comprise an electrocardiogram (ECG), electroencephalogram (EEG), or an electromyogram (EMG), which all measure biopotentials, i.e., electrical signals indicative of physiologic activity of an organ or part of the human or animal body. Other forms of electrography which may be used to acquire corresponding signals in the form of waveforms may include electrocorticography or intracranial EEG (iEEG or ECOG), which is EEG with direct contact to the cerebral cortex, electrooculography (EOG), which is electrography of intraocular potential differences, electroolfactography (EOG), which is electrography of olfaction (smell), electroretinography (ERG), which is electrography of retinal cell action potentials; electronystagmography (ENG), which is electrography of eye muscle movements, electrocochleography (ECOG), which is electrography of cochlear auditory activity; electroantennography (EAG), which is electrography of insect antennae olfaction, electrogastrography (EGG), which is electrography of stomach smooth muscle, electrogastroenterogram (EGEG), which is electrography of stomach and bowel smooth muscle, electroglottography (EGG), which is electrography of glottal movement, electropalatography (EPG), which is electrography of palatal contact of the tongue, etc.

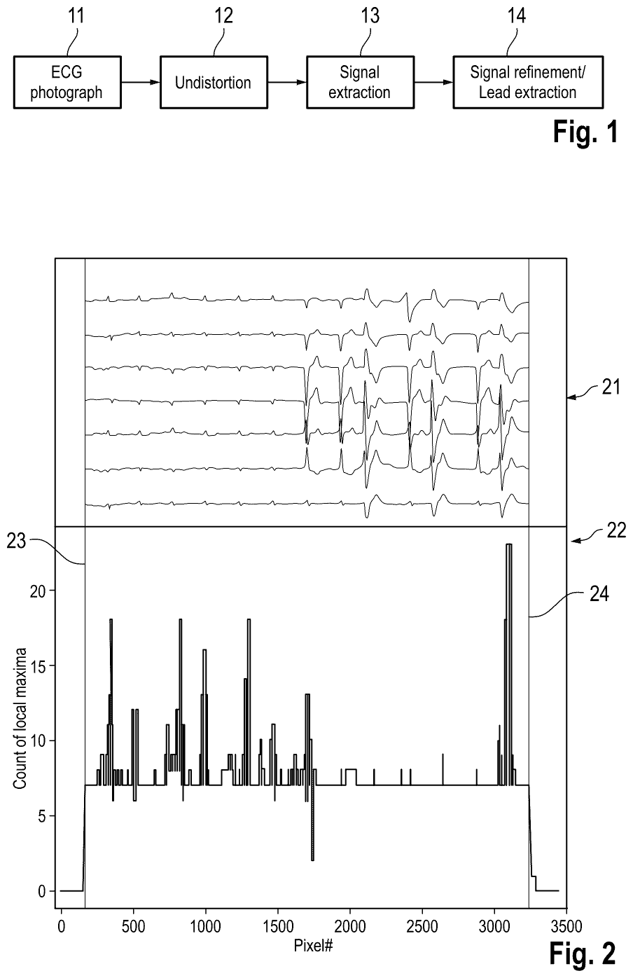

Due to the focus of the following detailed description on a set of ECG signals, the terms “(ECG) signal(s)” and “lead(s)” will be used herein. However, it is noted that this is done without the intent to limit the disclosure with regard to the nature of the waveforms which may be processed by means of the various methods of the present invention. FIG. 1 illustrates an exemplary process flow based on the method for extracting pixel trajectories representing waveforms according to various embodiments. An advantage of the present method is that a photograph of a paper-based ECG may be used as input. Therefore, in a first step 11, a photograph of an ECG is either provided to the algorithm from storage or taken, e.g., captured be camera or other image capture device. Here, a simple snapshot of the paper-based ECG with a camera from a mobile phone, for example, (or retrieval of a previously captured image) is sufficient. In a second step 12, undistortion of the image may take place, e.g., when it cannot be guaranteed that the paper-based ECG has been flattened (or was flat enough) during image acquisition. For example, the paper on which the ECG is reproduced may be folded or otherwise distorted, in which the image may require an undistortion process, as described here. In a third step 13, signal extraction takes place. After this step, a grayscale image may be obtained which only contains signals (e.g., in a bright color) against their background (e.g., in a dark color). However, the individual signal traces may not be masked yet, e.g., the signal traces have not been detected or extracted yet. This may take place in a fourth step 14, where further steps of methods of the present invention, including lead extraction, are executed, optionally further including signal refinement.

Before the application of the methods according to various embodiments described herein to a digital image of the leads, the digital image may be subject to an undistortion process first, as already noted in the context of FIG. 1. An example undistortion process which may be used for that purpose is disclosed in the international application no. PCT/EP2022/055201, which is incorporated by reference herein in its entirety. In some embodiments, the undistortion process may be applied to a digital image of the photograph of the ECGs to provide an undistorted graphical representation of the ECG signals from paper-form recordings.

In some embodiments, once undistortion has been applied, a processor may execute additional operations to automatically detect the region of interest within the input image. Such detection may rely on artificial intelligence models, including convolutional neural networks trained on large sets of annotated ECG images, or generative AI models configured to produce bounding boxes that enclose waveform content while excluding irrelevant margins, artifacts, or labels. In further embodiments, heuristic algorithms may be used to identify areas of high pixel density or recurring linear gridlines, which may serve as indicators of regions where leads are most likely to be present. The ability to automatically isolate a region of interest may reduce computational overhead by focusing processing resources on relevant image segments while discarding extraneous background areas.

In additional embodiments, the processor may determine the orientation of the input image by analyzing textual or graphical features embedded within the recording. For example, lead labels such as “I,” “II,” “III,” “a VR,” or “V1-V6” may be recognized using optical character recognition techniques, and calibration markings may be detected by searching for repeating tick marks or scale indicators. Based on this information, the processor may rotate or flip the image to ensure consistent alignment of the leads along expected horizontal baselines. Orientation correction may also account for inverted photographs, mirror images, or rotated scans, thereby reducing error in subsequent segmentation and baseline identification steps. In some embodiments, the system may further employ statistical validation to confirm that the corrected orientation corresponds to physiologically plausible waveform patterns, ensuring robustness of the orientation correction process across heterogeneous input sources.

In some embodiments, various methods of the present invention may be applied to photographs containing ECGs (or, as noted above, any other kind of waveforms), preferably to undistorted photographs of waveforms obtained by pre-processing of the aforementioned kind. Therefore, in a first step, a grayscale image of ECG signals recorded on a paper (or other equivalent material or substrate) may be obtained. For the purpose of waveform digitization, the process of signal extraction from digital images of the paper-based recording of the waveforms may play an important role. During that process, each pixel, preferably in a region of interest, may be classified as background or signal.

In one example scenario, the image segmentation model used to obtain a grayscale image segmented from digitized signals recorded on paper may be based on a neural network, e.g., a fully convolutional DNN, utilizing, for example, the U-net architecture (Ronneberger et al., 2015). In an example embodiment, to train the model for the purpose of providing input data for further processing by the method of the present invention, a plurality of ECG images of various resolutions may be used. These images may be subdivided into non-overlapping pixel patches of predetermined resolution, such as square patches having sides on the order of hundreds of pixels. To improve the performance of the model, pseudo-noisy ECG scans containing changes such as shadows, rotations, distortions, color and contrast changes, overlapping text or random noise of various strengths have been also generated and used. The pseudo-noisy data may form a portion of the training set, for example between 10% and 50% of the overall data, thereby improving robustness to real-world acquisition conditions. A separate validation set, comprising a plurality of ECG images, may be used to evaluate generalization performance of the trained model. In operation, the trained model may process image patches and reconstruct corresponding segmentation masks, which may then be reassembled to form a grayscale image of the full input record. The resulting mask represents, for each pixel, a value indicative of confidence that the pixel corresponds to a signal trace, thereby serving as input for subsequent lead extraction steps.

In some embodiments, the reconstruction process may employ advanced neural network architectures executed by one or more processors to segment waveform structures from the input image. For example, the processor may implement a U-Net model, a U-Net enhanced with residual connections that improve gradient flow, or a transformer-based segmentation model configured to leverage attention mechanisms for capturing long-range dependencies across the image. In operation, the processor may supply pixel patches to the network and receive as output a segmentation mask in which lead pixels are distinguished from background regions. The accuracy of such segmentation may be quantified by overlap-based similarity measures such as Dice coefficient, intersection-over-union, pixel-wise precision and recall, or receiver operating characteristic analysis, each providing different indicators of alignment between predicted and reference masks.

In further embodiments, training data for such models may comprise manually annotated electrocardiogram images in which each visible lead is independently labeled. Annotations may be validated by superimposing the segmentation masks onto the original images and visually verifying alignment between predicted and true signal traces. In some embodiments, validation of annotated datasets may further include procedures to measure inter-annotator agreement, such that multiple human reviewers confirm the placement of lead boundaries with a high degree of consistency. In additional embodiments, automated quality-control checks may be applied to detect systematic errors in labeling, such as consistent shifts away from the true baseline or incomplete tracing of a lead. These validation procedures may ensure that training data maintain a high level of reliability, thereby improving the generalization performance of models trained on such datasets.

Annotation procedures may also include inter-annotator agreement checks or quality control audits to ensure reliability of the labels. To improve robustness, training may additionally incorporate augmentation processes, such as introducing synthetic distortions that mimic real-world acquisition conditions. For example, the processor may randomly apply contrast variation, skewing, shadow overlays, printing artifacts, JPEG compression noise, or background text interference, thereby enabling the model to generalize across heterogeneous image sources. In still further embodiments, augmentation may extend to geometric transformations such as rotation or perspective warping, ensuring that the trained model remains resilient even when the input ECG image is captured at an oblique angle or under suboptimal lighting conditions.

In some embodiments, the generation of a segmentation mask may not be limited to deep neural networks but may instead be accomplished using conventional image processing techniques executed by at least one processor. For example, thresholding operations may be performed, such as global thresholding, Otsu's adaptive thresholding, or histogram-based adaptive thresholding, in order to distinguish signal pixels from background pixels based on intensity distribution. In further embodiments, edge detection algorithms, including Sobel filters, Canny edge detection, or Laplacian operators, may be applied to emphasize sharp transitions corresponding to waveform traces. Contour extraction routines, such as OpenCV contour tracing methods, may then convert detected edges into continuous paths representing candidate signal structures.

In additional embodiments, instance segmentation approaches may be employed in which region proposal networks, such as those implemented in Mask R-CNN, generate bounding boxes that are refined into pixel-level masks for each lead. Mask R-CNN or related instance segmentation architectures may allow multiple leads within the same image to be identified as distinct instances, reducing ambiguity in crowded or overlapping regions. In still further embodiments, quantum computing algorithms may be utilized to brute-force evaluate segmentation hypotheses by representing candidate pixel groupings in a qubit superposition. A quantum processor may thereby evaluate multiple segmentation outcomes in parallel and return the configuration with the highest confidence, which may be determined by a likelihood function combining pixel intensity, continuity with neighboring pixels, and distance from an expected baseline. These additional mask generation alternatives may be used independently or in conjunction with neural network-based segmentation, providing flexibility for heterogeneous input conditions and ensuring that reliable segmentation is available across a wide variety of image sources and qualities.

Once a grey-scale image has been obtained, in some embodiments, the image processing method of the present invention may be applied thereto, which aims at extracting pixel trajectories representing the ECG signals. A goal of the method according to the invention is to identify the ECG signal pixels (or any other kind of signal pixels) in the grayscale image, assign them to correct leads and, if applicable, supplement missing parts and/or correctly resolve regions of intersecting ECG signals. In some embodiments, the layout of the ECG signals may be defined by parameters which may be provided by the user, e.g., input into a corresponding application, and/or may be otherwise predetermined. The supplied parameters may, for example, indicate one or more of the following: predetermined number of signals, number of rows comprising a signal, and/or relative position of the signals with respect to one another, etc. The beginning and the end of each row in the image and the baseline for each signal row may be determined by the present method itself or, if provided for, based on a corresponding user input.

In some embodiments, the grayscale segmentation mask may only contain the curves representing the leads and nothing else. That is, for each sampled time position (x-axis) a corresponding voltage may be indicated by the position of the pixel (y-axis) of the respective lead. According to a simplistic approach, it may suffice to bucket paint each row of pixels and see where the paint flows to, and extract the coordinates accordingly to trace each of the leads pixel-wise. However, there are drawbacks associated with that approach, such as missing segmented parts of the lead(s) or intersections of the leads, which would render this bucket paint approach imprecise or even lead to false results in the form of wrong identification of the individual leads.

In some embodiments, extraction of waveform data from the input image may be performed directly without first generating a segmentation mask. In such implementations, one or more processors may execute an end-to-end deep learning model configured to accept an input image and output a digitized time-series representation of the detected signals. Such a model may include convolutional layers to capture spatial features of the image, recurrent or transformer layers to preserve temporal dependencies, and fully connected layers that map extracted features to discrete amplitude values aligned with the temporal axis of the recording.

In further embodiments, generative artificial intelligence models may be used to reconstruct digital signals from static images by iteratively predicting the waveform trace in pixel space and then mapping those predictions into continuous numerical outputs. These models may include generative adversarial networks trained to synthesize waveform trajectories or diffusion models that gradually refine noisy trajectories into smooth signal reconstructions. In additional embodiments, quantum computing algorithms may be configured to evaluate numerous candidate pixel trajectories simultaneously by encoding alternative paths in a qubit superposition and applying quantum search techniques to identify the trajectory most consistent with baseline expectations.

Still further embodiments may employ genetic or evolutionary algorithms that maintain a population of candidate waveform paths and iteratively improve them through crossover and mutation operations, with a fitness function based on proximity to signal-intense pixels and continuity across columns. Bayesian inference techniques may also be employed to assign probabilities that a given pixel sequence corresponds to a true lead, combining priors such as expected baseline location with likelihood functions based on pixel intensity. In yet other embodiments, heuristic search methods including A*, best-first search, breadth-first search, or depth-first search may be adapted from navigation problems, in which the processor incrementally explores possible trajectories across the image and selects the path that minimizes cost functions defined by pixel brightness, smoothness, and distance from expected baselines.

In view of those issues, a method according to embodiments of the present invention provides for a different approach, which may be seen to substantially include at least one of the following steps: i) reduce the area of the digital image to a region of interest containing the leads, ii) localize at least the baselines of the leads, iii) divide the field containing the leads into separate parts, and iv) bucket paint as much of the leads as possible, while accepting that some segments (e.g., rows of pixels) may remain unprocessed. In particular, in some embodiments, intersecting or touching portions of the leads may be resolved subsequently in a further step (or group of steps).

In an initial step, in some embodiments, irrelevant parts of the image which do not comprise the leads may be discarded to focus on the region of interest comprising the leads. In order to do so, the grayscale image may be processed column by column. In each column of pixels (referred to herein as a test column), the one or more pixels which have grayscale values above a predetermined first threshold and/or which are located apart from one another by at least a certain distance, governed by a second threshold, may be identified as lead pixels. From a mathematical viewpoint, this step may correspond to determining local maxima in each test column (e.g., vertical line of pixels in the image), as these points should represent potential leads. In that manner, background pixels may be distinguished from signal pixels in each column.

In some embodiments, once the lead pixels have been determined, each one may be associated with its respective line and column number in the grayscale image and allocated a respective rank according to its appearance in the column, referred to as the lead index. The lead index may correspond to the number of the respective lead pixel when counting the lead pixels in a considered test column from top to bottom or vice versa. In regions where the leads do not touch and/or cross one another, the lead index may be seen to directly correspond to the number of the lead to which the lead pixel belongs. That is, each fifth lead pixel identified throughout the rows may be assumed to belong to the fifth signal in the digital image, for example.

In some embodiments, from the number of maxima per column, over the time axis (x-axis in the digital image), the starting point and the end point of each lead may be identified, as shown in FIG. 2. The upper image 21 in FIG. 2 shows an example segmentation mask, e.g., a grayscale image of a 12-lead ECG, comprising seven signal rows. In this example format, there are six leads in the left part of the image (I, II, III, aVF, aVR, aVL) spanning a 5 second time window, six leads on the right part (V1, V2, V3, V4, V5, V6) also spanning a 5 second time window, and one optional rhythm lead at the bottom spanning the whole 10 seconds intervals. In the upper image 21 of FIG. 2, the separation between the signals in the left part and the right part of the image is hardly visible.

At the bottom of FIG. 2, a histogram 22 is shown, in which the number of local maxima (y-axis) is graphed over the pixel number within the image (x-axis). The vertical lines 23, 24 running through both the upper digital image 21 and the histogram 22 mark the left and a right margins of the region of interest, which may be defined as the first column and a last column of the grayscale image. The margins may be seen to correspond to the first and last columns of pixels, which have a predetermined number of lead pixels, and there is no signal in the region to the left of the left margin and to the right of the right margin. As can be taken from the histogram 22 shown in FIG. 2, the number of local maxima in the region of the image between the left and right margin may vary, depending on the upper digital image 21. However, it may be seen that the mode of the number of the local maxima, which is seven in this example scenario, may correspond to the number of ECG leads present in the grayscale image. The number of detected local maxima may deviate from that number for various reasons, e.g., when the individual signals, which usually have a width which is more than one pixel, are steep (e.g., the number of detected maxima is larger) or when they overlap/cross, thus having shared lead pixels (e.g., the number of detected maxima is smaller). In addition, errors of the input image may contribute to noise in the image, which may increase the number.

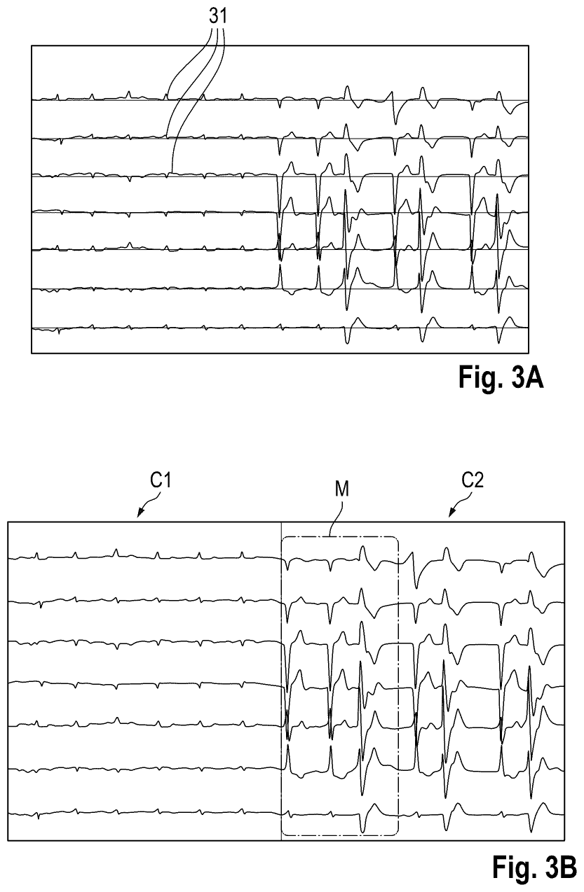

In some embodiments, once the beginning and the end of each signal have been determined, for each lead index associated with respective lead pixels throughout the individual columns, a median value (or average value, e.g., rounded to a whole number) of respective line numbers may be determined. The graphical representation of the median values for a given lead index corresponds to a baseline of the corresponding lead. The baselines 31, one for each of the individual signals, are shown in FIG. 3A as horizontal lines.

In some embodiments, the baseline may also be determined using alternative statistical and image analysis techniques. For example, the processor may construct column-wise intensity histograms and locate prominent peaks corresponding to signal paths. In other implementations, extremal pixel values may be selected, such as the brightest or darkest pixel per column, depending on whether the waveform appears as a dark trace on a light background or vice versa. These alternatives may be used independently or in combination with median-based approaches, thereby providing resilience in cases where signal traces are irregular, distorted, or partially occluded. In some embodiments, the processor may implement a hybrid approach in which baselines initially determined by median calculations are validated against histogram-derived or extremal-pixel baselines. If discrepancies are detected between the two measures, the system may reconcile them by weighting the results or by selecting the baseline supported by a majority of indicators. Such cross-checking may further increase robustness in scenarios where noise, overlapping signals, or inconsistent print quality introduce uncertainty into baseline placement. By offering multiple strategies for baseline detection, the system may maintain accuracy across heterogeneous input sources and variable image quality conditions. As a further improvement of the method, for the determination of the baselines 31 from the median value of the line numbers, in some embodiments, only those columns may be taken into account where the count of local maxima is equal to the actual number of leads, as indicated by the mode of the number of the local maxima in the histogram 22 of FIG. 2.

Once the baselines 31 are established, in some embodiments, noise in the top and/or the bottom part of the input image may be eliminated, e.g., by cutting out the corresponding portions of the image. The behavior of the ECG signal is generally well-known, e.g., a maximal excursion of the ECG signals from their corresponding baselines, and based on that knowledge the input image may be cropped. For case of further processing of the signals, the image may be split into multiple parts, e.g., two parts or columns C1, C2, as shown in FIG. 3B (the baselines 31 are omitted in FIG. 3B), each part C1, C2 comprising seven leads in accordance with the present example. In order to execute the splitting, in some embodiments, gaps in the segmentation mask may be detected. If the gaps are in the expected places, e.g., if they cut the image in a uniform way, they may be used for splitting the image into parts. For a segmentation mask comprising 12 ECG signals, represented in 6 rows, 2 columns C1, C2 of ECG signals need to be present, such that one gap is expected in the center region of the segmentation mask. Alternatively, the image may be split in a non-uniform way, e.g., by splitting the image into two portions in accordance with the known number of ECG signal columns, each having the same width.

In some embodiments, the actual lead extraction may be executed in each part C1, C2 of the image separately. The task to be solved at this stage of the method according to various embodiments is to identify all lead pixels of each lead. In a first phase, the bucket paint approach may be used to paint the individual leads as long as i) the lead being painted is not getting too far from its baseline detected beforehand, ii) there is another segment of the lead close to it (this condition helps to prevent false resolution of intersections between leads), and iii) the lead is not disappearing (this condition covers any of the cases of having a weak input image or when the signal is really disappearing on the actual ECG paper).

In some embodiments, the first phase outlined above may include an iterative process in which each column is scanned for local maxima (e.g., brightest pixels), which correspond to potential lead pixels. If the conditions outlined above are met and if there are a number of local maxima in the column which correspond to the number of leads, the respective lead pixel may be assigned to the lead according to the lead index of the lead pixel.

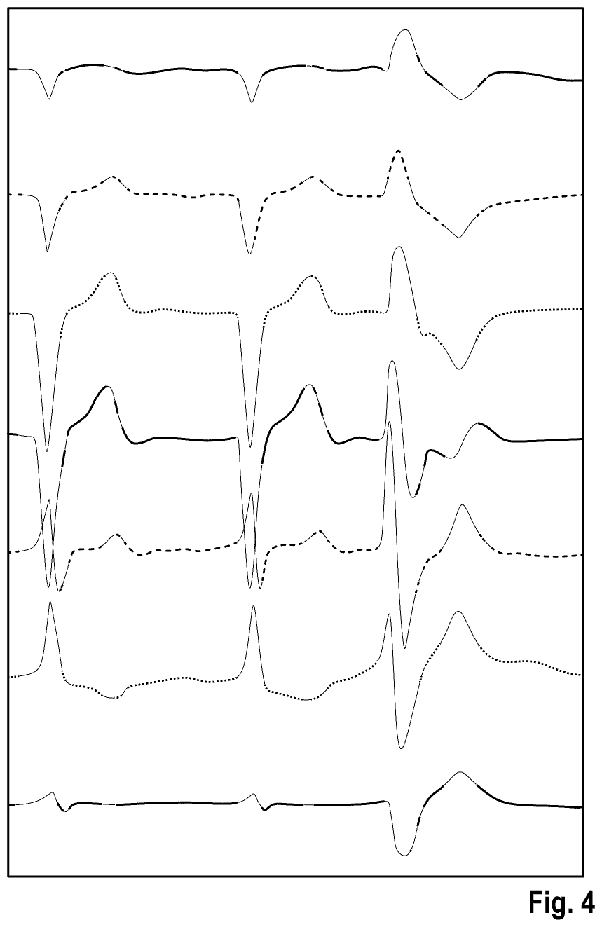

By applying this iterative process, e.g., column by column (though not restrictively: one or more columns may be also processed in parallel and/or in any other order), usually a substantial fraction of the leads may be extracted. For simple and non-overlapping ECG signals, such as for the leads in the left part of FIG. 3B, all lead pixels may be extracted by the process outlined above, such that up to 100% of the leads may be extracted. In cases where the ECG signals overlap, such as for the leads shown in the right part of FIG. 3B, in some embodiments, only fractions of the leads may be extracted, as reflected in the image shown in FIG. 4. The image of FIG. 4 comprises the portions of the ECG signals from the marked region M in the right part C2 of FIG. 3B, wherein the portions of the leads which have been extracted by applying the strict conditions are highlighted in bold. In addition, though not require in all embodiments, the image has been stretched for a better visibility of the highlighted portions of the ECG signals, e.g., the portions of the leads which have been detected so far. It may be seen that in this phase of the method various portions of the leads remain undetected, such as the steep peaks of the leads and regions where the leads intersect/cross.

It is noted that, due to the “ordered” nature of the signals in the first part C1 of the segmentation mask shown in FIG. 3B, up to 100% of the leads may be detected during the phase of the method which yields the result shown in FIG. 4 relating to the second part C2 of the segmentation mask. That is, the protocol including the iterative search over each column (e.g., sequentially over each column) for local maxima (brightest pixels along the vertical line which are potential leads) with the application of the assumption that if a pixel is sufficiently bright and close enough to the expected baseline and if there is the expected number of local maxima in the column, the identified pixel should be a lead pixel and is thus assigned to the lead, may provide sufficient results for well-separated and non-overlapping leads.

In some embodiments of the method of the present invention, if a section of any of the leads in the processed part of the image has not been extracted yet (e.g., due to a mismatch between the number of baselines and the number of lead pixels), this section may not be considered at this stage of the process, meaning that it may not be processed to extract lead pixels of the other leads either. Those sections, which may be referred to as remaining regions, may be dealt with in a subsequent phase of the method.

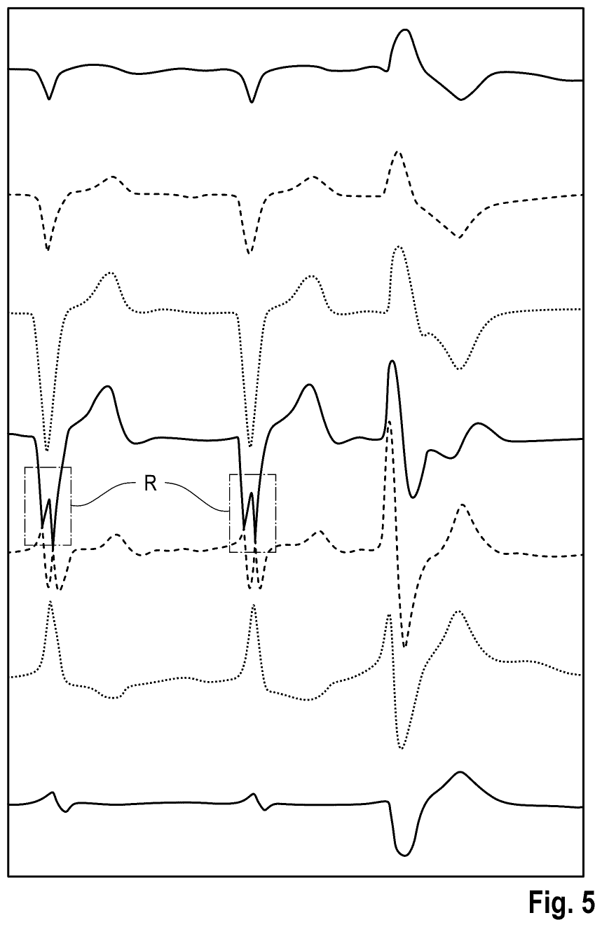

In order to extract more lead pixels which have not been extracted in the first phase, in some embodiments, the iterative process may be applied to the columns where lead pixels have not been detected, but with less strict conditions. For example, in some embodiments, the previously applied strict conditions may be adjusted such that the lead pixels do not have to be as close to the respective baseline as previously (the baselines are omitted in FIG. 4). For example, the strict condition may be replaced by the condition that it is sufficient for a lead pixel to be close (defined, for example, by a corresponding closeness threshold) to already identified parts of the lead. This way, starting from the result depicted in FIG. 4, further portions of the ECG signals may be extracted. In order to obtain the result illustrated in FIG. 5, practically the same step as before may be applied, but instead of using the distance of a sufficiently bright pixel to the corresponding baseline, in some embodiments, the distances from lead pixels which have been identified in the vicinity may be used close-by. During this step, not all lead pixels have to be identified in a column in order to assign them: Fewer lead pixels (than the number of leads would indicate) may be also assigned, as the pixels are close to the already assigned lead pixels. With this approach, significantly more lead pixels may be detected, as may be seen by comparing the portion of detected leads between FIG. 4 and FIG. 5.

In some embodiments, additional post-processing operations may be executed by one or more processors to refine the set of pixels associated with each lead after the initial segmentation or extraction stage. The refinement process may involve filtering noise using techniques such as median filtering, morphological opening and closing, or adaptive thresholding to eliminate isolated artifacts that do not correspond to genuine signal pixels. In further embodiments, the processor may identify regions of interest by analyzing column-wise distributions of local maxima, thereby ensuring that computational resources are concentrated on areas where signal density exceeds background density. Once regions of interest are established, the processor may segment the grayscale image into discrete vertical strips corresponding to individual leads, after which baseline positions may be recalculated to ensure alignment with the true centerlines of the signals.

In additional embodiments, the processor may extend partially reconstructed trajectories across missing or degraded image regions by applying linear interpolation, spline fitting, or polynomial regression anchored to adjacent valid segments. Endpoints of truncated signals may be projected toward expected baseline positions or areas exhibiting high intensity gradients, thereby reconnecting fragmented leads into continuous traces. In some implementations, overlapping or intersecting regions may be resolved using continuity heuristics that prioritize the assignment of pixels to the trajectory exhibiting the most consistent directional progression across adjacent columns. Such heuristics may be implemented as graph traversal algorithms that evaluate multiple possible path assignments and select the option that minimizes discontinuity and abrupt curvature. In this manner, the post-processing operations may improve both the completeness and morphological fidelity of the reconstructed waveforms, thereby enabling subsequent clinical or computational analysis to be performed on cleaner, more accurate digital signals.

In various embodiments, the extraction process outlined herein may be applied in forward direction and/or in backward direction, sequentially and/or simultaneously. In some embodiments, the results of the forward and backward run may be combined.

In some embodiments, possible intersection/touching regions, where two leads intersect or just touch, may still need to be accounted for. As shown in FIG. 5, for example, there are two dense regions R, in which the fourth lead from the top and the fifth lead from the top intersect. However, from the point of view of the algorithm, this fact may not be known and, in particular, due to the allocation of detected lead indices in accordance with their appearance in a column to respective lead indices and thus to the corresponding leads, the algorithm may not yet know if a touching point of two leads is, in fact, a touching point or a point of intersection. In the dense regions, the segments of the intersecting leads may therefore be allocated incorrectly. This may lead to an unnatural appearance and sharp double-peak structures of the peaks.

In some embodiments, the extraction process may incorporate user interaction as part of a hybrid workflow that combines automated algorithms with human guidance. For example, a graphical interface may be presented to a user on a display device, enabling the user to manually select anchor points along one or more waveforms. These anchor points may be stored in system memory and used by the processor to constrain or refine the automated trajectory assignment, thereby reducing ambiguity in regions where signal overlap or distortion is significant. In other embodiments, the user may adjust lead positions that have been automatically identified, dragging or repositioning trajectories to more accurately align with visible traces.

In further embodiments, user intervention may extend to the correction of ambiguous or missing regions where two or more leads intersect or where the automated algorithm has failed to detect a continuous path. A processor may receive such corrective inputs through a mouse, touch screen, stylus, or other input device and integrate them directly into the ongoing signal reconstruction process. In some implementations, the system may log all user interactions as an audit trail, thereby creating a record of manual corrections that can be used for regulatory compliance or quality assurance purposes. The human-in-the-loop approach may be particularly useful in clinical environments where signal fidelity is critical and where even small deviations in waveform morphology can influence diagnostic interpretation. In these cases, the combination of automated extraction and targeted user validation may increase both the reliability and clinical acceptability of the digitized records.

In some embodiments, in order to resolve the problem of possibly incorrectly allocated lead segments, the following rule may be implemented in the method according to various embodiments: if two leads share the same path, e.g., if they touch by sharing the same pixel, separate and “meet” again, then the paths/segments are swapped. Here it is important to recognize that, at this stage, intersections of leads may not be foreseen in the context of the method, so intersecting leads may be falsely interpreted as touching leads. The swapping of the segments between two touching points of two leads which are close enough (e.g., governed by a corresponding threshold) remedies this false interpretation. If, on the contrary, the leads do not meet again, e.g., if they do not share touching points which are located close enough (with respect to the threshold) to one another, then the touching point is determined to be a touching point of the leads and a swap may be performed.

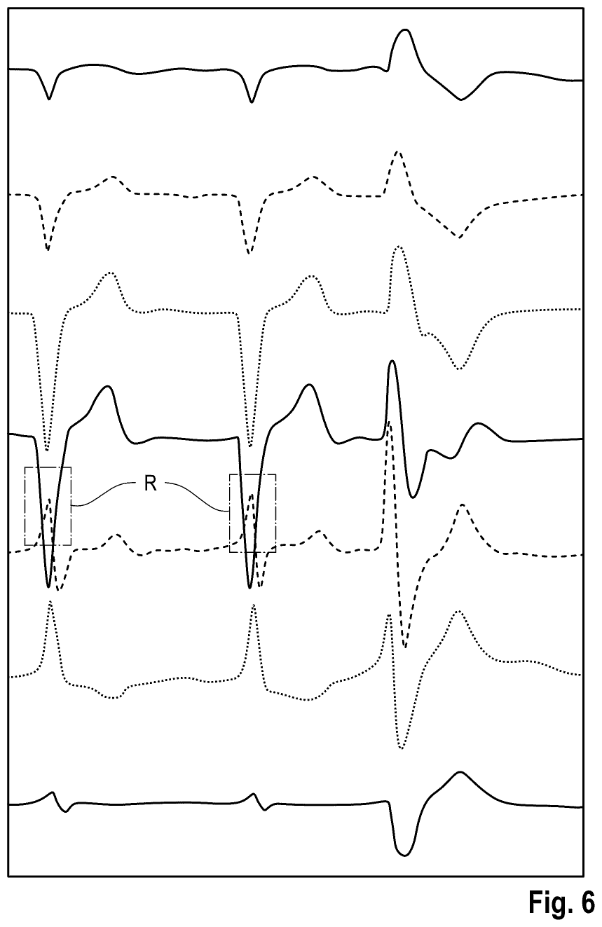

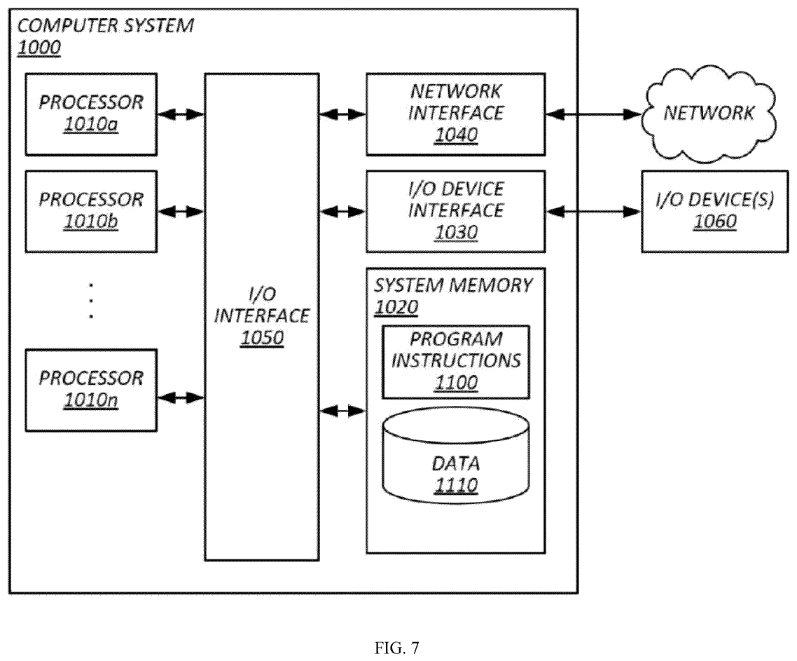

FIG. 6 illustrates the state of the signal extraction from the step illustrated in FIG. 5 after signal swapping according to an embodiment of the invention. As can be seen in the example embodiment, the touching points of the leads are sufficiently close to one another (e.g., with respect to a predefined threshold) and swapping of the segments of the leads in the dense regions corrects the false allocation.

In an example scenario, the first threshold, e.g., the minimal brightness (in the first step/screening) may be, e.g., 100 on a grayscale from 0 to 255. The second threshold, e.g., the minimal distance of pixels in different rows (in the first step/screening) may be, e.g., 64 pixels. This value may be suitable for the case of an algorithm which uses a constant grid size of 64 pixels by 64 pixels (in reality, the squares typically have a size of 5 mm by 5 mm). That is, in an example case, if the paper image has a size of 20 cm by 30 cm, the grid shape is formed by 40 rows by 60 columns, resulting in an image resolution of 2560 pixels by 3840 pixels. In a further example case, if the paper image covers an area of 10 cm by 20 cm, the grid shape is formed by 20 rows by 40 columns, resulting in an image resolution of 1280 pixels by 2560 pixels. Thus, overall, while the image resolution is adapted to the size of the paper image, the grid, e.g., the unit cells quantifying the signals are preferably constant, which may facilitate the evaluation and help in finding the optimal value for the second threshold.

Finally, the third threshold, e.g., the minimal brightness (in a further step of pixel assignment) may be, e.g., 60 on a grayscale from 0 to 255. In some embodiments, those example thresholds may be obtained experimentally, e.g., by collecting thousands of digital images and iteratively optimizing the digitization metric (curve distance between the prediction and reality), or may be otherwise calculated or provided.

Some embodiments may execute the above operations on a computer system, such as the computer system of FIG. 7, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Clause 1. A computer-implemented method for extracting pixel trajectories representing waveforms, referred to as leads, from a digital image, formed by lines and columns of picture elements, pixels, of a recording of an electrical activity of a human organ detected by on-skin electrodes, such as an electrocardiogram, ECG, or an electroencephalogram, EEG, wherein the electrical activity comprises a predetermined number of signals from respective electrodes recorded in subsequent rows oriented along lines in the digital image, the method comprising: obtaining a grayscale image segmented from digitized ECG or EEG signals recorded on a substrate comprising paper; in each column of pixels in the segmented grayscale image, referred to as test column, designating one or more pixels in a respective test column, having grayscale values above a predetermined first threshold, as candidate lead pixels, and designating candidate lead pixels which are consecutively apart more than a predetermined second threshold and in the case of vertically neighboring candidate lead pixels correspond to a middle candidate lead pixel as lead pixels by associating them with their respective line and column numbers in the segmented image and associating them with respective ranks according to their appearance in the test column, referred to as lead indices; determining a left and a right margin as first column and a last column of the segmented image which have a predetermined number of lead pixels associated with the first and the last column, respectively, and restricting the segmented image to the left and right margins while maintaining line and column numbers; and for each lead index associated with respective lead pixels, determining a median value of respective line numbers, referred to as baseline of said lead pixels.

Clause 2. The method of the preceding claim, further comprising: visiting each lead pixel, referred to as source pixel, of one or more pixel columns within the first and last column of the segmented grayscale image, referred to as current columns, and for each source pixel in a respective current column, having a neighboring column devoid of lead pixels at most one subsequent column apart from the current column, repeating the following step: for each plurality of pixels, referred to as target pixels, at most a predetermined number of pixels up and down the current column and said neighboring column, respectively, searching in a respective plurality of target pixels for a target pixel having a grayscale value above a predetermined third threshold and yielding a mean grayscale value of pixels between the source pixel and a said target pixel above a predetermined third threshold; and if a target pixel has been found, designating said target pixel as lead pixel by associating it with its line and column number in the segmented image and associating it with the lead index associated with the source pixel.

Clause 3. The method according the preceding claim, wherein said method is additionally carried out for each source pixel in a respective current column, having a neighboring column devoid of lead pixels at most one preceding column apart from the current column.

Clause 4. The method of any of the preceding claims, wherein designating a pixel as lead pixel is restrictable by a distance of said pixel to a corresponding baseline.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B.

Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method for extracting leads from a digital image, comprising:
obtaining a grayscale image segmented from one or more digitized signals;
in each column of pixels in the segmented grayscale image:
designating one or more pixels in a respective test column having grayscale values above a predetermined first threshold as candidate lead pixels, and
designating candidate lead pixels which are consecutively apart more than a predetermined second threshold, or for vertically neighboring candidate lead pixels corresponding to a middle candidate lead pixel, as lead pixels by:
associating the candidate lead pixels with their respective line numbers and column numbers in the segmented grayscale image; and
associating them with respective ranks according to their appearance in the test column, referred to as lead indices;
determining a left margin as a first column and a right margin as a last column of the segmented grayscale image, wherein a predetermined number of lead pixels are associated with the first column and the last column, respectively, and restricting the segmented grayscale image to the left and right margins while maintaining line numbers and column numbers; and
for each lead index associated with respective lead pixels, determining a baseline of said lead pixels.

2. The method according to claim 1, further comprising:
visiting one or more source pixels of one or more pixel columns within the first column and the last column of the segmented grayscale image, and
for each source pixel in a respective current column, having a neighboring column devoid of lead pixels at most one subsequent column apart from the current column, repeating the following step:
for each of a plurality of target pixels, at most a predetermined number of pixels at least one of up or down the current column and said neighboring column, respectively:
searching in a respective plurality of target pixels for a target pixel having a grayscale value above a predetermined third threshold and yielding a mean grayscale value of pixels between the source pixel and a said target pixel above a predetermined third threshold; and
if a target pixel has been found, designating said target pixel as lead pixel by associating it with its line number and column number in the segmented grayscale image and associating it with the lead index associated with the source pixel.

3. The method according to claim 2, wherein said method is additionally carried out for each source pixel in a respective current column having a neighboring column devoid of lead pixels at most one preceding column apart from the current column.

4. The method according to claim 1, wherein designating a pixel as a lead pixel is restrictable by a distance of said pixel to a corresponding baseline.

5. The method according to claim 1, wherein the image is recorded on a substrate comprising paper.

6. The method according to claim 1, wherein the one or more digitized signals comprise recordings of the electrical activity of a human organ detected by on-skin electrodes.

7. The method according to claim 6, wherein the recording of the electrical activity is one of electrocardiogram (ECG) or electroencephalogram (EEG) signals.

8. The method according to claim 6, wherein the electrical activity comprises a predetermined number of signals from respective electrodes recorded in subsequent rows oriented along lines in the digital image.

9. The method according to claim 1, wherein determining the baseline of said lead pixels comprises determining the median value of respective line numbers.

10. A system for extracting leads from a digital image, comprising:
a processor;
a memory connected to the processor; and
one or more code sets stored in the memory and executing in the processor, which, when executed configure the system to:
obtain a grayscale image segmented from one or more digitized signals;
in each column of pixels in the segmented grayscale image:
designate one or more pixels in a respective test column having grayscale values above a predetermined first threshold as candidate lead pixels, and
designate candidate lead pixels which are consecutively apart more than a predetermined second threshold, or for vertically neighboring candidate lead pixels corresponding to a middle candidate lead pixel, as lead pixels by:
associating the candidate lead pixels with their respective line numbers and column numbers in the segmented grayscale image; and
associating them with respective ranks according to their appearance in the test column, referred to as lead indices;
determine a left margin as a first column and a right margin as a last column of the segmented grayscale image, wherein a predetermined number of lead pixels are associated with the first column and the last column, respectively, and restricting the segmented grayscale image to the left and right margins while maintaining line numbers and column numbers; and
for each lead index associated with respective lead pixels, determine a baseline of said lead pixels.

11. The system according to claim 10, further configured to:
visit one or more source pixels of one or more pixel columns within the first column and the last column of the segmented grayscale image, and
for each source pixel in a respective current column, having a neighboring column devoid of lead pixels at most one subsequent column apart from the current column, repeat the following step:
for each of a plurality of target pixels, at most a predetermined number of pixels at least one of up or down the current column and said neighboring column, respectively:
search in a respective plurality of target pixels for a target pixel having a grayscale value above a predetermined third threshold and yielding a mean grayscale value of pixels between the source pixel and a said target pixel above a predetermined third threshold; and
if a target pixel has been found, designate said target pixel as lead pixel by associating it with its line number and column number in the segmented grayscale image and associating it with the lead index associated with the source pixel.

12. The system according to claim 11, further configured to execute for each source pixel in a respective current column having a neighboring column devoid of lead pixels at most one preceding column apart from the current column.

13. The system according to claim 10, wherein designating a pixel as a lead pixel is restrictable by a distance of said pixel to a corresponding baseline.

14. The system according to claim 10, wherein the image is recorded on a substrate comprising paper.

15. The system according to claim 10, wherein the one or more digitized signals comprise recordings of the electrical activity of a human organ detected by on-skin electrodes.

16. The system according to claim 15, wherein the recording of the electrical activity is one of electrocardiogram (ECG) or electroencephalogram (EEG) signals.

17. The system according to claim 15, wherein the electrical activity comprises a predetermined number of signals from respective electrodes recorded in subsequent rows oriented along lines in the digital image.

18. The system according to claim 10, wherein determining the baseline of said lead pixels comprises determining the median value of respective line numbers.

19. A non-transitory computer-readable media comprising instructions that, when executed by one or more processors, cause operations comprising:
obtaining a grayscale image segmented from one or more digitized signals;
in each column of pixels in the segmented grayscale image:
designating one or more pixels in a respective test column having grayscale values above a predetermined first threshold as candidate lead pixels, and
designating candidate lead pixels which are consecutively apart more than a predetermined second threshold, or for vertically neighboring candidate lead pixels corresponding to a middle candidate lead pixel, as lead pixels by:
associating the candidate lead pixels with their respective line numbers and column numbers in the segmented grayscale image; and
associating them with respective ranks according to their appearance in the test column, referred to as lead indices;
determining a left margin as a first column and a right margin as a last column of the segmented grayscale image, wherein a predetermined number of lead pixels are associated with the first column and the last column, respectively, and restricting the segmented grayscale image to the left and right margins while maintaining line numbers and column numbers; and
for each lead index associated with respective lead pixels, determining a baseline of said lead pixels.

20. The non-transitory computer-readable media of claim 19, further comprising:
visiting one or more source pixels of one or more pixel columns within the first column and the last column of the segmented grayscale image, and
for each source pixel in a respective current column, having a neighboring column devoid of lead pixels at most one subsequent column apart from the current column, repeating the following step:
for each of a plurality of target pixels, at most a predetermined number of pixels at least one of up or down the current column and said neighboring column, respectively:
searching in a respective plurality of target pixels for a target pixel having a grayscale value above a predetermined third threshold and yielding a mean grayscale value of pixels between the source pixel and a said target pixel above a predetermined third threshold; and
if a target pixel has been found, designating said target pixel as lead pixel by associating it with its line number and column number in the segmented grayscale image and associating it with the lead index associated with the source pixel.
